(19) United States
(12) Patent Application Publication
(10) Pub. No.: US 2018/0082506 A1
(43) Pub. Date: Mar. 22, 2018

(54) Output Protection Assembly and Transaction Machine

(71) Applicant: CSPtec B.V., Houten (NL)

(72) Inventors: Cornelis Johannes Goedee, Houten (NL); Marina Helena De Jongh, Houten (NL)

(21) Appl. No.: 15/555,763

(22) PCT Filed: Mar. 4, 2016
(86) PCT No.: PCT/NL2016/050154

§ 371 Date: Sep. 5, 2017

(30) Foreign Application Priority Data
Mar. 4, 2015 (NL) 2014398

(51) Int. Cl. G07D 11/00; G07F 19/00

(52) U.S. Cl. CPC G07D 11/0018; G07F 19/205

(57) ABSTRACT

Disclosed is a dispenser protective assembly, such as an assembly for protecting a dispensing opening for a number of sheets, such as banknotes, for application in an automatic transaction machine, such as a cash dispenser. The assembly includes at least one protective member arrangeable in a protective position relative to the dispensing opening and means for mounting the protective member in the protective position relative to the dispensing opening. The at least one protective member extends substantially from one side of the opening to another side of the opening. The assembly includes means for guiding the number of sheets from a dispensing direction out of the automatic transaction machine to a direction at an angle to this dispensing direction. These guide means form an obstruction to the insertion of an object into the dispensing opening.

The present invention relates to a dispenser protective assembly, such as a dispenser protective assembly for protecting a dispensing opening for a number of sheets, such as banknotes, for application in an automatic transaction machine with the dispensing opening, such as a cash dispenser. The present invention also relates to an automatic transaction machine comprising such a dispenser protective assembly.

Transactions at automatic transaction machines are subject to risks. Such risks involve forms of improper appropriation of means, such as banknotes, to be dispensed from the automatic transaction machine. Different means are utilized for this purpose in everyday practice.

The first risk is preventing dispensing from the automatic machine of banknotes by means of an inserted, so-called cash claw. Such a device is a metal strip which is inserted through the dispensing opening of an automatic transaction machine and remains there for a time. When a bank customer attempts to obtain banknotes from the automatic machine, hooking means of the cash claw prevent the notes being dispensed from the machine. Once the bank customer has left empty-handed, the cash claw is taken out of the dispensing opening of the machine together with the banknotes.

The second risk is preventing dispensing from the automatic machine of banknotes by means of a strip with adhesive material adhered to the dispensing opening and facing toward the interior of the machine. The strip is not recognizable as such for the bank customer. When a bank customer attempts to obtain banknotes from the automatic machine, the arranged strip prevents dispensing of the banknotes while the banknotes remain adhered to the adhesive material. It is here also the case that, once the bank customer has left empty-handed, the strip is taken from the dispensing opening of the machine together with the banknotes.

The present invention provides means for preventing these risks. It is emphasized here that different measures of different preferred embodiments are aimed to differing extent at preventing different of these risks.

The present invention provides a dispenser protective assembly, such as a dispenser protective assembly for protecting a dispensing opening for a number of sheets, such as banknotes, for application in an automatic transaction machine with the dispensing opening, such as a cash dispenser, the dispenser protective assembly comprising:
at least one protective member arrangeable in a functional protective position relative to the dispensing opening,
mounting means for mounting the protective member in the functional protective position relative to the dispensing opening, wherein:
the at least one protective member extends substantially from one side of the dispensing opening to another side of the dispensing opening;
the dispenser protective assembly comprises guide means for guiding the number of sheets from a dispensing direction out of the automatic transaction machine to a direction at an angle to this dispensing direction;
wherein these guide means form an obstruction to the insertion of an object into the dispensing opening.

According to a first preferred embodiment, the dispenser protective assembly is suitable for protecting a substantially elongate rectangular dispensing opening, preferably comprising for this purpose two elongate protective members. It is hereby particularly suitable for protecting dispensing openings of a cash dispenser or the like.

In the position of use the protective members more preferably allow in front view a throughfeed of an object with a smaller height than the dispensing opening allows, preferably allows throughfeed when the object is curved, more preferably so that flat throughfeed of a plate-like object is obstructed. The sheets, such as the banknotes, can be dispensed in curved form. A bracket which can result in fraud at the cash dispenser cannot be inserted. Also prevented is that damage can be caused to the automatic machine or the guard which closes the dispensing opening.

According to a further preferred embodiment, the dispenser protective assembly comprises a sealable and/or tamper-proof mounting assembly, the mounting assembly comprising:
a throughfeed element preferably provided with mounting means such as a screw thread or a contact surface,
an indicator such as a conductive member, such as a conductive wire or fibre,
a first indicator guide member movable relative to the throughfeed element and comprising at least a first guide for the indicator,
a second indicator guide member movable relative to the throughfeed element and comprising at least a second guide for the indicator,
wherein the at least one first guide and the at least one second guide are arrangeable for mutual co-action with the indicator,
a retaining member such as a clamp or nut for retaining the first indicator guide member or the second indicator guide member relative to the throughfeed element.

It hereby becomes possible to detect whether someone is attempting to remove the protective members from the automatic machine. A detection is realized when the retaining member retains the first or second indicator guide member. Such a device also provides memory function because it is subsequently possible to determine that such an attempt has been made.

Further advantages, features and details of the present invention will be described in greater detail hereinbelow on the basis of one or more preferred embodiments with reference to the accompanying figures. Similar though not necessarily identical components of different preferred embodiments are designated with the same reference numerals.

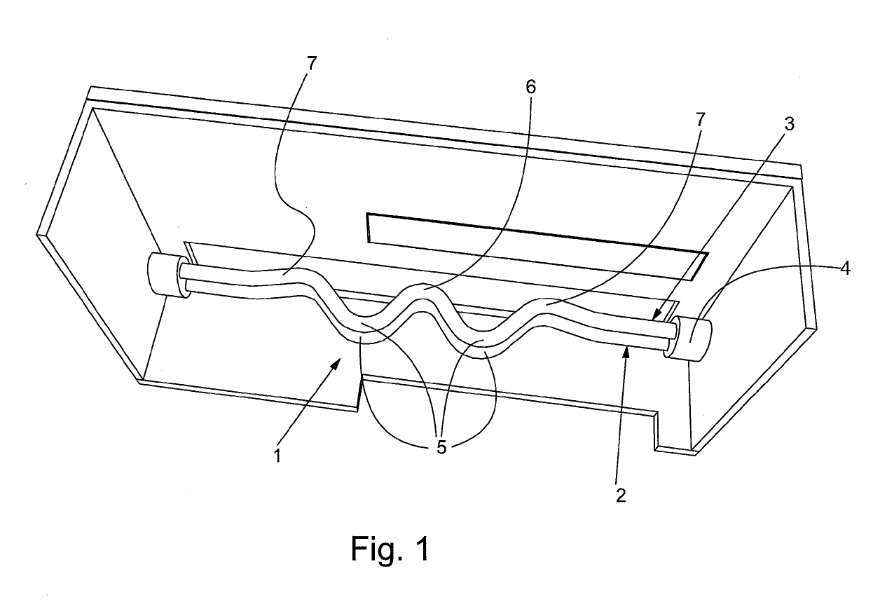

FIG. 1 is a perspective view of a first preferred embodiment according to the present invention mounted on an automatic transaction machine.

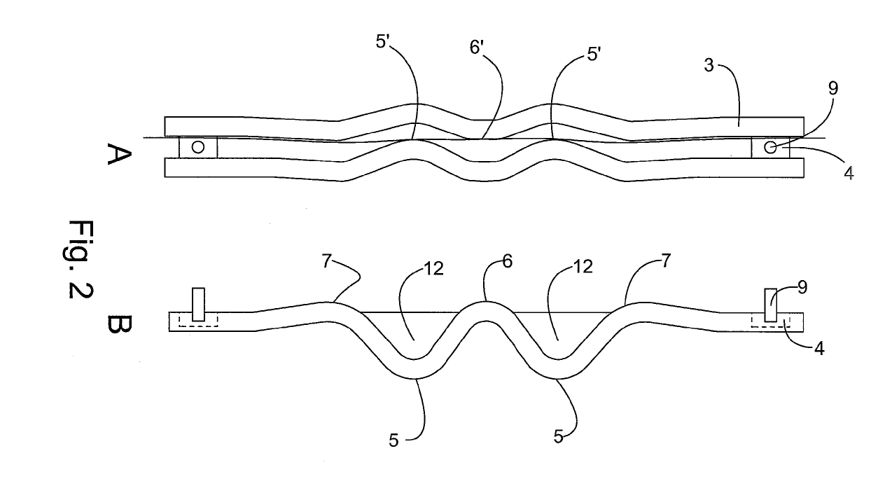

FIG. 2 shows three schematic views of a further preferred embodiment according to the present invention.

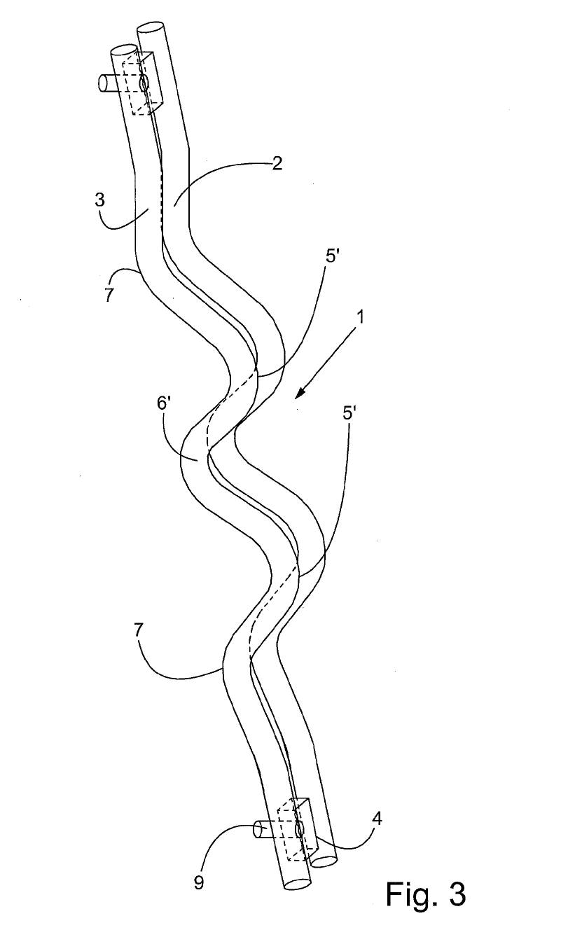

FIG. 3 is a schematic perspective view of the preferred embodiment according to FIG. 2.

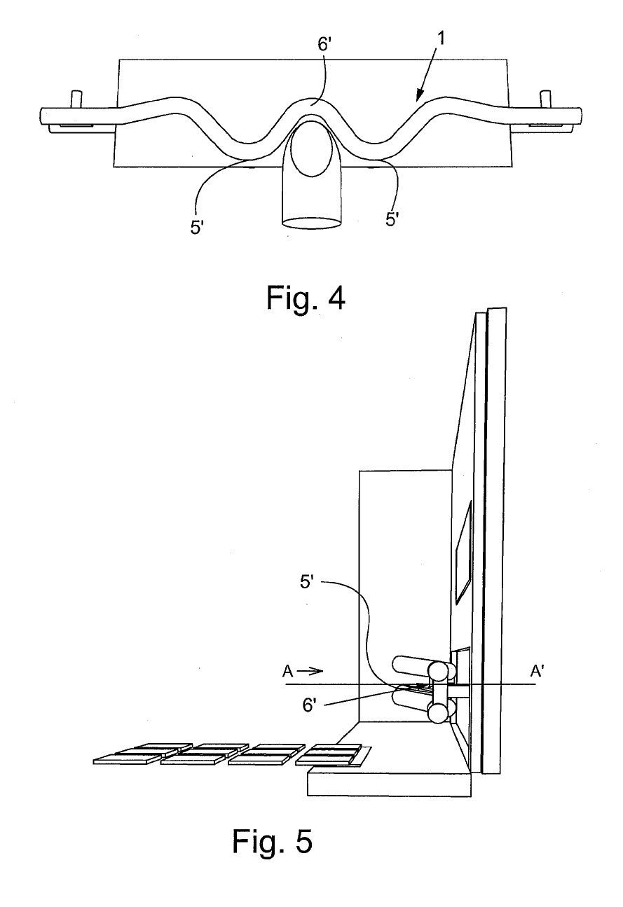

FIG. 4 is a perspective view of the preferred embodiment according to FIG. 1 during use.

FIG. 5 is a schematic side view of the preferred embodiment according to FIG. 2.

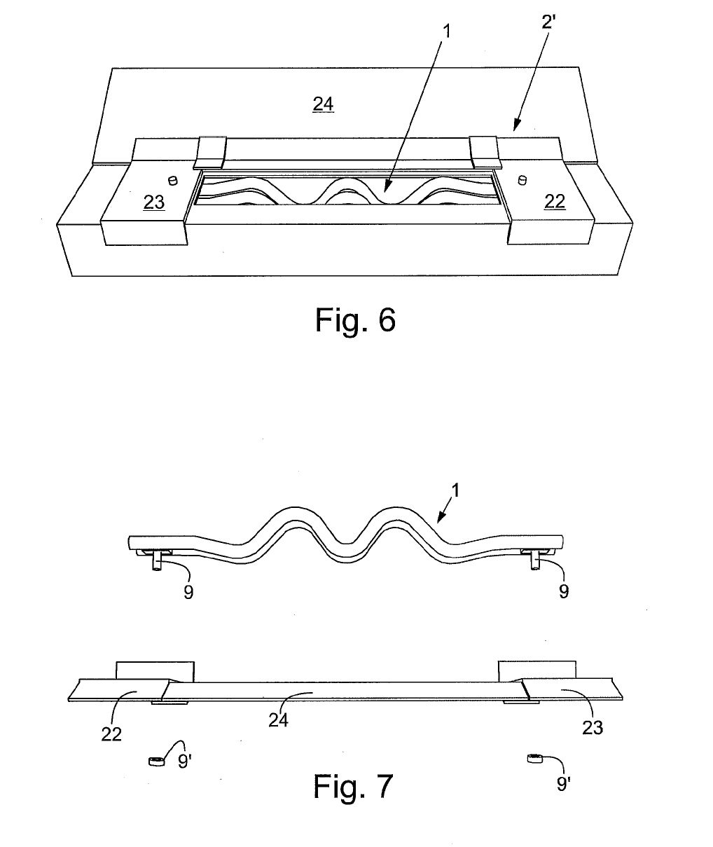

FIG. 6 is a perspective view of a further preferred embodiment.

FIG. 7 is a cut-away perspective view of the preferred embodiment according to FIG. 6.

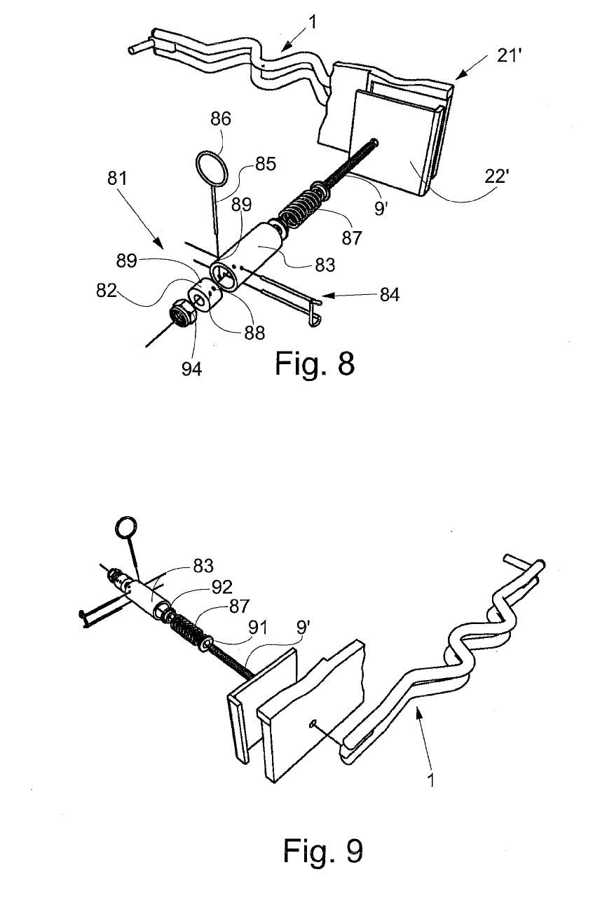

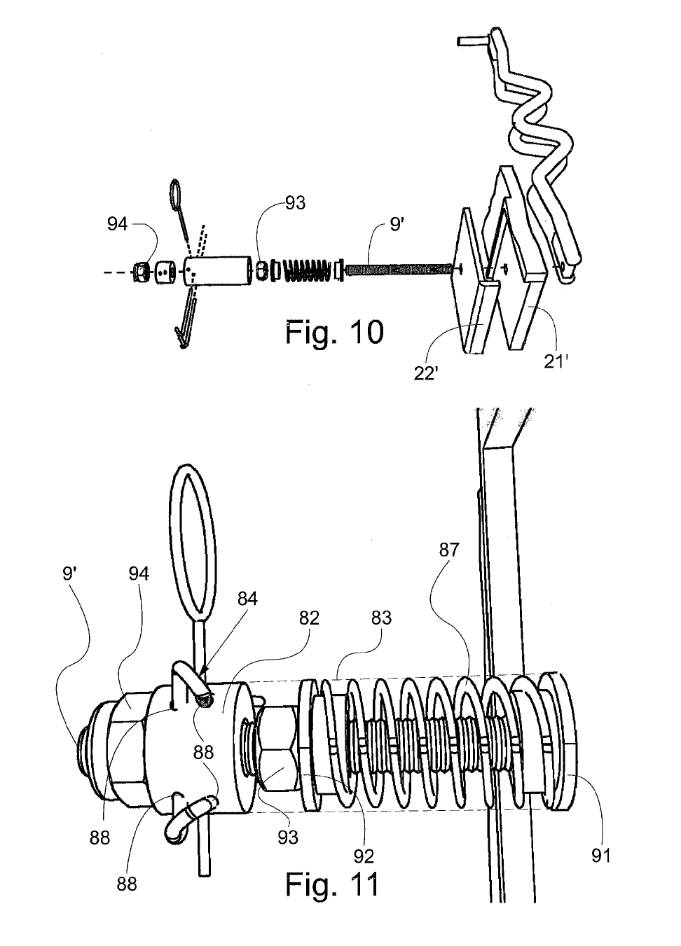

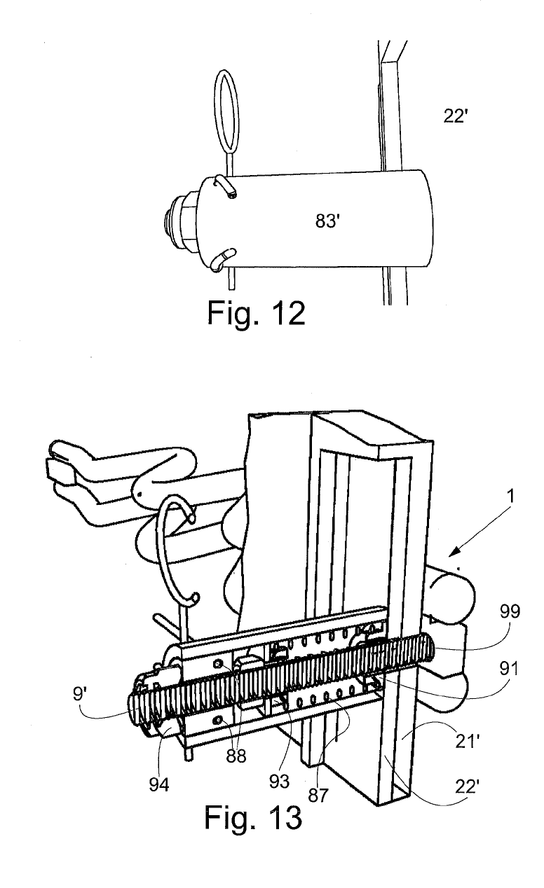

FIGS. 8-13 show diverse views of a further preferred embodiment according to the present invention.

A first preferred embodiment (FIG. 1) according to the present invention relates to a dispenser protective assembly 1. This comprises a lower protective member embodied as a rod 2. It also comprises an upper protective member embodied as a rod 3. Mounting elements 4 fix rod 2 and rod 3 to each other. Mounting elements 4 further provide a mounting option for mounting the assembly on the automatic machine. Use is made for this purpose of two bolts 9 extending to the rear from mounting elements 4 (see FIG. 2).

Significant advantages of the present invention are achieved due to the shape of the respective rods 2, 3 and the relative arrangement of rod 2 and rod 3. Both rods have for this purpose substantially the same shape. In a view corresponding to a top view when laid flat on a surface the rod 2 has the following two features.

From the mounting points, which correspond during use to the front side of the dispensing opening of the automatic transaction machine, the rod runs with a slight rearward curve to an apex 7. This apex 7 serves for arrangement lying against or a short distance from the closing guard of the dispensing opening. This closing guard forms part of the automatic machine per se. From apex 7 the rod runs with a bend in the direction of apex 5, then with a bend in the direction of the rearward oriented apex 6, then with a bend in the direction of the forward oriented apex 5 and then with a bend in the direction of rearward oriented apex 7, and ends at the opposite end.

Shown in the front view by means of auxiliary line H during use in front of the dispensing opening is that the upper side of apex 5′ of lower rod 2 impinges on the auxiliary line from below while the underside of apex 6′ of upper rod 3 impinges on the auxiliary line from above. This prevents it being possible to insert a cash claw into the dispensing opening of the automatic transaction machine. Also achieved is that notes can be fed through between the two rods (shown in FIG. 4).

On the machine side the opening between the two rods is situated during use at the position of the regular dispensing opening for the stack of notes. On the side remote from the automatic machine the opening between the two rods is situated somewhat higher during use due to the angle relative to the plane of dispensing made by the curves of the rods. This can be seen clearly in FIG. 5. Also shown in FIG. 5 is an auxiliary line, which auxiliary line shows clearly in side view that these upward oriented curves of the rods block a plane of insertion of a cash claw.

The placing of an adhesive strip in front of the dispensing opening is prevented by the respective apexes 6 and 7, the rear side of which is arranged substantially against or a short distance from the guard during use. This prevents there being space for arranging an adhesive strip behind respective apexes 6 and 7. This also prevents the possibility of a tool obtaining grip on the guard, whereby it cannot be raised. Applying more than one rod provides a height between the upper side of the upper rod and the underside of the guard such that the use of a breaking tool is obstructed to significant extent.

FIGS. 6 and 7 show mounting of the assembly on a front F of the automatic machine. The two bolts 9 are insertable into two holes in the front of the machine. Two optional counter-elements 22, 23 are arranged on the inner side of the front of the machine. These counter-elements are optionally mutually connected by means of a strengthening bridge 24. The two bolts 9 are fixable by means of nuts 9′.

The counter-elements and the bridge are provided as additional reinforcement of the assembly. The bridge provides an additional reinforcement against breaking open of the guard of the dispenser by means of a tool. The counter-elements provide additional reinforcement against pulling on the rods from the outside. Provided for the purpose of impeding fastening of a rope to the rods are insert elements 12, embodied for instance in sheet material such as steel, whereby feeding of cable through the bend in the rod is prevented. Envisaged in alternative manner is embodying the dispenser protective members in a sheet material instead of a rod material.

The preferred embodiment according to FIGS. 8-13 serves to provide detection of attempts to destroy or remove the guide means. A mounting pin 9′ of protective assembly 1 has for this purpose a mounting assembly with an indicator 84. The indicator is embodied as a damageable wire or fibre. This wire or fibre has a conductor for electricity or for instance light. When the conductor is interrupted, detection takes place.

Detection is realized in that the indicator is fed through through-openings 88 of the inner indicator guide member, preferably referred to as the first indicator guide member. It is simultaneously fed here through corresponding openings in the outer indicator guide member. These two indicator guide members are arranged coaxially in each other around wire 9′ when the guide members are pulled on from outside the machine, the inner indicator guide member will be displaced by nut 94 relative to the outer indicator guide member which supports against strengthening plate 22′. The wire will hereby break and the conduction will be interrupted, whereby indication takes place.

This manner of detection is possible without the use of biasing member 87. Biasing member 87 or spring 87 is applied for the purpose of providing a mechanical resistance. During placing of the assembly the threaded end 9′ is first screwed into opening 99.

Ring 91, spring 87 and ring 93 are then arranged. Depending on the embodiment, the first indicator guide member 82 is then arranged directly, with the installation fixation element 85 fixing the first indicator guide member 82 relative to second indicator guide member 83.

Nut 94 is then tightened until the installation fixation element 85 can slide freely, substantially without resistance, into and out of the opening. In this position of the nut the indicator is safely in the through-openings.

In alternative manner an additional nut 93 is applied to hold the spring under bias. The bias of the spring can hereby be set independently of the position of first indicator guide member 82. The indicator is connected to a measuring circuit of the installation in which it is applied for the purpose of forwarding an indication to for instance a control centre.

The indicator can have a number of transitions between the inner and the outer indicator guide members. A larger number provides a greater reliability of severing of the indicator. The device provides a memory function since it is subsequently possible to determine that the indicator has been severed.

The first and second indicator guide members are preferably embodied by means of a non-conductive material in order to prevent a short-circuit after severing of the indicator.

An alternative definition of the invention relates to a dispenser protective assembly such as a dispenser protective assembly for protecting a dispensing opening for a number of sheets, such as banknotes, for application in an automatic transaction machine with the dispensing opening, such as a cash dispenser, the dispenser protective assembly comprising:
at least one protective member arrangeable in a functional protective position relative to the dispensing opening,
mounting means for mounting the protective member in the functional protective position relative to the dispensing opening, wherein:
the at least one protective member extends substantially from one side of the dispensing opening to another side of the dispensing opening;
the dispenser protective assembly comprises a barrier for blocking the access to the dispensing opening, preferably for obstructing placing of an adhesive strip in front of the dispensing opening. This embodiment is particularly suitable for preventing placing of the adhesive strip.

An alternative definition of the invention relates to a sealable and/or tamper-proof mounting assembly, the mounting assembly comprising:
a throughfeed element preferably provided with mounting means such as a screw thread or a contact surface,
an indicator such as a conductive member, such as a conductive wire or fibre,
a first indicator guide member movable relative to the throughfeed element and comprising at least a first guide for the indicator,
a second indicator guide member movable relative to the throughfeed element and comprising at least a second guide for the indicator,
wherein the at least one first guide and the at least one second guide are arrangeable for mutual co-action with the indicator,
a retaining member such as a clamp or nut for retaining the first indicator guide member or the second indicator guide member relative to the throughfeed element.

The mounting assembly more preferably comprises installation fixation means for co-action with an installation fixation element for mutual fixation of the first indicator guide member and the second indicator guide member, wherein a respective installation fixation element can be applied for temporary mutual fixation thereof. The mounting assembly more preferably comprises a resistance assembly, such as a resistance element, such as a biasing member such as a spring. The resistance assembly is more preferably arrangeable between a part of the throughfeed element oriented toward and/or fixed to the dispenser protective assembly and a further part of the throughfeed element remote from the dispenser protective assembly.

The resistance assembly is more preferably arranged in the mounting assembly against a stop formed either by one of the first and/or the second indicator guide members or a mounting element such as a clamp or a nut.

The first and/or second guide is more preferably provided with through-openings for guiding the indicator therethrough, wherein during use the through-openings provide a continuous channel with at least one indication transition between the first indicator guide member and the second indicator guide member, wherein a relative displacement of the respective indicator guide members preferably results in an indication being caused by loss of conduction, more preferably by damage, such as severing, of the indicator.

Advantages as described in the foregoing are realized in independent manner by means of these described embodiments of the mounting assembly.

An alternative definition of the invention is a method for mounting a dispenser protective assembly according to one or more of the foregoing claims in an object to be protected, comprising steps for:
providing the dispenser protective assembly,
providing the sealable and/or tamper-proof mounting assembly,
arranging the first indicator guide member and the second indicator guide member on the throughfeed element with an indicator arranged thereon, or arranging the indicator,
placing the retaining member at a determined position for the purpose of retaining the first indicator guide member or the second indicator guide member relative to the throughfeed element.

The steps for arrangement are preferably performed here while applying an arranged installation fixation element, the method also comprising steps for removing the installation fixation element. Such a method more preferably comprises steps for placing the resistance assembly prior to arranging the indicator guide members.

The present invention has been described in the foregoing on the basis of several preferred embodiments. Different aspects of different embodiments are deemed described in combination with each other, wherein all combinations which can be deemed by a skilled person in the field as falling within the scope of the invention on the basis of reading of this document are included. These preferred embodiments are not limitative for the scope of protection of this document. The rights sought are defined in the appended claims.

1. A dispenser protective assembly, such as a dispenser protective assembly for protecting a dispensing opening for a number of sheets, such as banknotes, for application in an automatic transaction machine with the dispensing opening, such as a cash dispenser, the dispenser protective assembly comprising:
at least one protective member arrangeable in a functional protective position relative to the dispensing opening,
mounting means for mounting the protective member in the functional protective position relative to the dispensing opening, wherein:
the at least one protective member extends substantially from one side of the dispensing opening to another side of the dispensing opening;
the dispenser protective assembly comprises guide means for guiding the number of sheets from a dispensing direction out of the automatic transaction machine to a direction at an angle to this dispensing direction;
wherein these guide means form an obstruction to the insertion of an object into the dispensing opening.

2. The dispenser protective assembly as claimed in claim 1 suitable for protecting a substantially elongate rectangular dispensing opening, preferably comprising for this purpose two elongate protective members.

3. The dispenser protective assembly as claimed in claim 1, wherein in the position of use the protective members allow in front view a throughfeed of an object with a smaller height than the dispensing opening allows, preferably allows throughfeed when the object is curved, more preferably so that flat throughfeed of a plate-like object is obstructed.

4. The dispenser protective assembly as claimed in claim 1, wherein the at least one protective member is a curved rod or tube.

5. The dispenser protective assembly as claimed in claim 1, wherein the at least one protective member comprises at least one, such as two or three, forward directed curves.

6. The dispenser protective assembly as claimed in claim 1, wherein the at least one protective member comprises at least one, such as two or three, up-ward directed curves, preferably at an angle of 10-80°, more preferably at an angle of 20-60°, more preferably at an angle of 20-30° relative to the horizontal dispenser.

7. The dispenser protective assembly as claimed in claim 5, wherein the at least one upward directed curve is formed from the same physical means as the at least one forward directed curve.

8. The dispenser protective assembly as claimed in claim 1, wherein each protective member is a curved rod or tube and wherein bends in the rod or tube form the guide means, and wherein these bends form in mounted state the obstruction to insertion of an object into the dispensing opening.

9. The dispenser protective assembly as claimed in claim 1, comprising guard protecting means for protecting a guard of the dispensing opening.

10. The dispenser protective assembly as claimed in claim 9, wherein the guard protecting means are formed by at least one rear side of the at least one protective member extending rearward from a straight line in front of the dispensing opening, more preferably at least one rearward extending apex of the at least one protective member.

11. The dispenser protective assembly as claimed in claim 1, wherein the at least one protective member is formed from a sheet material.

12. The dispenser protective assembly as claimed in claim 1, wherein the at least one protective member is formed from materials such as a metal such as steel, stainless steel, or a composite such as fibre-reinforced plastic.

13. The dispenser protective assembly as claimed in claim 1, comprising at least one counter-element for arranging on the side of the dispenser remote from the at least one protective member.

14. The dispenser protective assembly as claimed in claim 13, comprising two counter-elements arrangeable on either side of the dispensing opening, preferably further comprising a bridge element for connecting the two counter-elements, more preferably wherein the two counter-elements and the bridge element are embodied as a strengthening element.

15. The dispenser protective assembly as claimed in claim 1, comprising a surface layer realized by means of a surface treatment providing a lesser adhesion of fouling substances compared to an un-treated surface, such as by means of compressing a surface layer of the material.

16. The dispenser protective assembly as claimed in claim 1, comprising a sealable and/or tamper-proof mounting assembly, the mounting assembly comprising:
a throughfeed element preferably provided with mounting means such as a screw thread or a contact surface,
an indicator such as a conductive member, such as a conductive wire or fibre,
a first indicator guide member movable relative to the throughfeed element and comprising at least a first guide for the indicator,
a second indicator guide member movable relative to the throughfeed element and comprising at least a second guide for the indicator,
wherein the at least one first guide and the at least one second guide are arrangeable for mutual co-action with the indicator,
a retaining member such as a clamp or nut for retaining the first indicator guide member or the second indicator guide member relative to the throughfeed element.

17. The dispenser protective assembly as claimed in claim 16, comprising installation fixation means for co-action with an installation fixation element for mutual fixation of the first indicator guide member and the second indicator guide member, wherein a respective installation fixation element can be applied for temporary mutual fixation thereof.

18. The dispenser protective assembly as claimed in claim 16, comprising a resistance assembly, such as a resistance element, such as a biasing member such as a spring.

19. The dispenser protective assembly as claimed in claim 16, wherein the resistance assembly is arrangeable between a part of the throughfeed element oriented toward and/or fixed to the dispenser protective assembly and a further part of the throughfeed element remote from the dispenser protective assembly.

20. The dispenser protective assembly as claimed in claim 18, wherein the resistance assembly is arranged against a stop formed either by one of the first and/or the second indicator guide members or a mounting element such as a clamp or a nut.

21. The dispenser protective assembly as claimed in claim 16, wherein the first and/or second guide is provided with through-openings for guiding the indicator therethrough, wherein during use the through-openings provide a continuous channel with at least one indication transition between the first indicator guide member and the second indicator guide member, wherein a relative displacement of the respective indicator guide members preferably results in an indication being caused by loss of conduction, more preferably by damage, such as severing, of the indicator.

22. The dispenser protective assembly as claimed in claim 1, wherein the dispenser guide means comprise guide surfaces for directing the sheets between two respective guide rods.

23. A dispenser protective assembly, such as a dispenser protective assembly for protecting a dispensing opening for a number of sheets, such as banknotes, for application in an automatic transaction machine with the dispensing opening, such as a cash dispenser, the dispenser protective assembly comprising:
at least one protective member arrangeable in a functional protective position relative to the dispensing opening,
mounting means for mounting the protective member in the functional protective position relative to the dispensing opening, wherein:
the at least one protective member extends substantially from one side of the dispensing opening to another side of the dispensing opening;
the dispenser protective assembly comprises barrier means for blocking the access to the dispensing opening, preferably for obstructing placing of an adhesive strip in front of the dispensing opening.

24. An automatic transaction machine comprising a dispenser protective assembly as claimed in claim 1.

25. The method for mounting a dispenser protective assembly as claimed in claim 1 in an object to be protected, comprising steps of:
providing the dispenser protective assembly,
providing the sealable and/or tamper-proof mounting assembly,
arranging the first indicator guide member and the second indicator guide member on the throughfeed element with an indicator arranged thereon, or arranging the indicator,
placing the retaining member at a determined position for the purpose of retaining the first indicator guide member or the second indicator guide member relative to the throughfeed element.

26. The method as claimed in claim 25, wherein the steps for arrangement are performed while applying an arranged installation fixation element, the method also comprising steps for removing the installation fixation element.

27. The method as claimed in claim 25, comprising steps for placing the resistance assembly prior to arranging the indicator guide members.
